(19) United States
(12) Patent Application Publication
(10) Pub. No.: US 2003/0219544 A1
(43) Pub. Date: Nov. 27, 2003

(54) Thermal spray coating process with nano-sized materials

(76) Inventors: William C. Smith, Chillicothe, IL (US); Kurtis C. Kelley, Washington, IL (US); Daniel C. Coy, Naperville, IL (US); W. Ian Roberts, Joliet, IL (US)

Correspondence Address: CATERPILLAR INC., 100 N.E. ADAMS STREET, PATENT DEPT., PEORIA, IL, 616296490

(21) Appl. No.: 10/154,199

(22) Filed: May 22, 2002

(51) Int. Cl. B05D 1/08

(52) U.S. Cl. 427/446

(57) ABSTRACT

A method for coating materials on substrates is disclosed which includes providing a dispersion of the coating material in a liquid carrier wherein the material includes individual, non-agglomerated particles having diameters of less than 500 nanometers, injecting the dispersion into a thermal spray to form droplets of liquid carrier and particles, burning the droplets of liquid carrier and particles within the thermal spray so the particles begin to melt and wherein, as the droplets burn, at least some of the particles begin to form agglomerates of particles within the droplets and directing the droplets containing the agglomerates of particles toward the substrate to coat the substrate with the particles.

### TECHNICAL FIELD

The present invention relates to a thermal spray coating process, improved substrate coatings and improved thermal spray systems. More specifically, a thermal spray coating process and system is disclosed wherein a dispersion of nano-sized particle materials in a liquid carrier is injected into a gun or thermal spray device and, as the liquid carrier burns, the nano-sized particle material is directed at the surface of the substrate to be coated.

### BACKGROUND

High velocity oxygen fuel (HVOF) thermal spray processes are used to deposit coatings on various substrates. Generally, a powdered material, in an agglomerated or aggregate form, is mixed with a carrier gas and the mixture is injected into a spray device or gun with oxygen and a source of fuel, as the fuel combusts, the agglomerated particles are sprayed toward the substrate to be coated. HVOF thermal spray process cannot be used for ceramic or powdered materials having high melting points because the combustion temperature generated by the burning fuel is insufficient to melt high melting point powdered materials as they travel through the thermal spray system towards the substrate.

An alternative approach is to utilize plasma thermal spray technology where flame temperatures exceed 10,000° C. While plasma sprayed coatings can provide excellent thermal barrier protection to the underlying substrate, such plasma sprayed coatings often exhibit unsatisfactory thermal shock resistance, unsatisfactory bond strength inferior densities and insufficient dielectric strengths. Plasma sprayed coatings also tend to be porous and require the application of a sealant topcoat in order to reduce the oxidation rate of the underlying metal substrate.

Thus, to avoid the above problems associated with plasma thermal spray technology, improvements in HVOF techniques have been made which are directed toward reducing the size or irregular structure of the powdered coating agglomerated particles. Specifically, U.S. Pat. No. 6,025,034 teaches the dispersion of powdered coating agglomerated particles in a liquid medium before they are spray-dried to form spherical nano-particle agglomerates. The spherical nano-particle agglomerates are then used in a thermal spray deposition technique.

The nano-particles agglomerates are synthesized using an organic solution reaction or aqueous solution reaction methods. Ultrasonic agitation must be used to form a colloidal dispersion or slurry of the agglomerates prior to injection with fuel and oxygen into the combination zone of a HVOF gun or spray device.

One problem associated with the above technique is the need to take a powdered feed, mix it with a liquid, and treat the resulting mixture with ultrasound to provide a colloidal dispersion or slurry. Specifically, it is difficult to continuously feed a powder on a production scale. Powder feed equipment is prone to malfunction which therefore reduces productivity. Further, the resulting colloidal dispersion or slurry is not stable, as the agglomerates will settle out of the dispersion if it is not used immediately. In other words, the colloidal dispersions or slurry has little or no shelf-life. Still further, even though the individual particles are nano-sized, they form agglomerates of a substantially larger size, and as a result, exhibit substantial wear and tear to pumping equipment that is used to deliver the dispersion to the HVOF gun. Specifically, agglomerated materials having overall sizes of 1000 nanometers or more impart undue wear and tear on pumps causing seals prematurely to weaken and fail.

The disclosed HVOF methods are directed at overcoming one or more of the problems addressed above.

### SUMMARY OF THE DISCLOSURE

In one sense, the present invention may be characterized as a method for coating a nano-sized particle material on a substrate. This method includes providing a dispersion of the nano-sized particle material in a liquid carrier, the material including individual, non-agglomerated particles having diameters of less than 500 nanometers. The dispersion is then injected into a thermal spray to form droplets of liquid carrier and particles. The droplets are burned within the thermal spray such that the particles begin to melt and at least some of the particles begin to form agglomerates of particles within the droplets. The agglomerating particles are directed toward the substrate.

In another aspect, the invention may also be characterized as a method for coating high melting point material on a substrate. Such method comprises the steps of (1) mixing the high melting point material with a liquid carrier to provide a dispersion of the material in the liquid carrier, the material including individual, non-agglomerated particles having diameters of less than 500 nanometers; (2) injecting the dispersion, together with oxygen into a thermal spray to form burning droplets of liquid carrier and particles so as to initiate the melting of the particles and wherein as the droplets of liquid carrier and particles burn, at least some of the particles begin to form agglomerates of particles within the droplets; and (3) spraying the droplets of liquid carrier and particles toward the substrate.

In yet another aspect, the invention may be characterized as a thermal spray deposition system comprising a thermal spray deposition device; a source of fuel and oxygen operatively coupled to the thermal spray deposition device for creating a thermal spray; one or more sources of nano-sized particles dispersed in a liquid carrier in flow communication with the thermal spray deposition device, the dispersion including individual, non-agglomerated nano-sized particles; a feedstock injection system for injecting one or more of the dispersions of nano-sized particles in the liquid carrier into the thermal spray; and a system controller for controlling the injection parameters of the feedstock injection system to control one of the composition and droplet size of the dispersions of nano-sized particles in the liquid carrier injected into the thermal spray.

The invention may also be characterized as a method of controlling a thermal spray coating process comprising the steps of: (1) operating a thermal spray deposition system having a source of fuel and oxygen to provide a thermal spray; (2) providing at least one source of nano-sized particles dispersed in a liquid carrier, the dispersion including individual, non-agglomerated particles having diameters of less than 500 nm; (3) injecting the dispersions of nano-sized particles within the liquid carrier into the thermal spray under conditions such that one of the droplet size of the dispersion of nano-sized particles within the liquid carrier and the composition of nano-sized particles injected into the thermal spray is precisely controlled; and (4) spraying the droplets of the dispersions of nano-sized particles within the liquid carrier toward a substrate to coat the substrate; wherein the physical characteristics and composition of the coating on the substrate are manipulated by controlling one of the content and droplet sizes of the dispersions of nano-sized particles within the liquid carrier injected in the thermal spray.

Finally, the invention may also be characterized as a high velocity oxygenated fuel (HVOF) coated article comprising a substrate, a coating of agglomerated nano-sized particles deposited on the substrate by high velocity oxygenated fuel (HVOF) thermal spray deposition process, wherein the agglomerated nano-sized particles being derived from a dispersion of the nano-sized, non-agglomerated particles in a liquid carrier injected into the thermal spray, and wherein the coating has a dielectric strength at least 20% greater than a dielectric strength of a like coating onto a like substrate using a plasma thermal spray process.

### BRIEF DESCRIPTION OF THE DRAWINGS

The above and other aspects, features and advantages of the present system and process for industrial paint operations will be more apparent from the following more particular description thereof, presented in conjunction with the following drawings, wherein:

FIG. 1 illustrates, schematically, a thermal spray system adapted for use with the described embodiments of the invention;

FIG. 2 illustrates, schematically, a particle coating/liquid carrier dispersion being injected into a combustion chamber of a HVOF spray gun and the development of individual droplets as the dispersion travels through the combustion chamber of the gun;

FIG. 3 illustrates, schematically, the process by which the individual nanometer-sized particles contained within dispersion droplet develop into agglomerates of nanometer-sized particles as the liquid carrier burns and the droplet size is reduced to provide an agglomeration of melting nanometer-sized particles in the burning droplet which are deposited onto the substrate;

FIG. 4 is an optical photograph of an alumina coating deposited on a substrate using the HVOF method disclosed herein;

FIG. 5 is an optical photograph of a titania-chromia coating deposited on the substrate using the HVOF method disclosed herein;

FIG. 6 is an optical photograph of another titania-chromia coating deposited on a substrate using the HVOF method disclosed herein; and

FIG. 7 is an optical photograph of a alumina-titania coating deposited on the substrate using the HVOF method disclosed herein.

### DETAILED DESCRIPTION

The following description is of the best mode presently contemplated for carrying out the invention. This description is not to be taken in a limiting sense but is made merely for the purpose of describing the embodiments of the invention. The scope of the invention should be determined with reference to the claims.

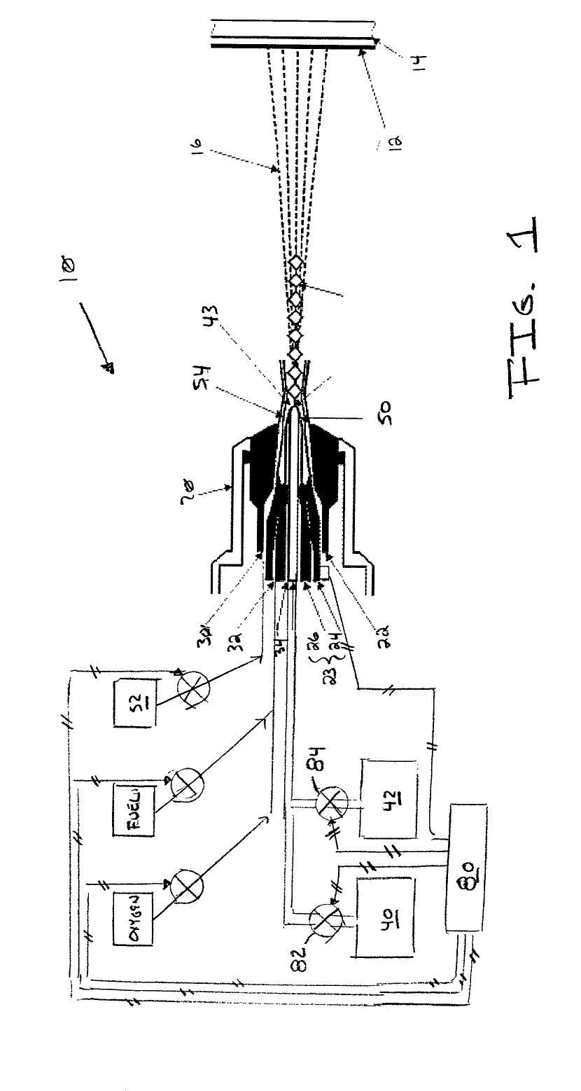

Turning to FIG. 1, there is shown a thermal spray system 10 adapted to deposit a coating 12 of nano-sized particles on a target substrate 14. The thermal spray system 10 operates so as to create a particle spray 16 that includes agglomerated nano-sized particles of high melting point materials to be deposited on the target substrate 14. The thermal spray system 10 includes an air cap housing or body 20; an air cap 22; a nozzle assembly 23 having a nozzle 24 and a nozzle insert 26. In the illustrated embodiment, the various components are co-axially arranged so as to define a series of feed conduits.

The feed conduits include a compressed air conduit 30 interposed between the air cap 22 and nozzle 24; and a fuel conduit 32 interposed between the nozzle 24 and the nozzle insert 26. In addition, there is a feedstock conduit 34 coaxially oriented with respect to the nozzle 24 to introduce one or more sources of liquid carrier and nano-sized particle material dispersions 40, 42 into the combustion chamber 43 of the thermal spray system 10. The fuel conduit 32 is adapted to supply a source of oxygen and fuel, such as oxygen-propane, oxygen-propylene, oxygen-hydrogen, or other mixture of oxygen and high combustion temperature fuels such as methylacetylenepolypropadiene (MAPP) to the combustion chamber 43. The oxygen-fuel mixture burns within the combustion chamber 43 to produce the characteristic luminous white cone of balanced oxygen-fuel flame 50. Into this oxygen-fuel flame 50 is introduced one or more sources of liquid carrier and nano-sized particle material dispersions 40, 42 via the feedstock conduit 34. The compressed air conduit 30 is adapted to carry deliver a source of compressed air 52 to the combustion chamber 43 of the thermal spray system 10. The compressed air forms an air envelope 54 surrounding the oxygen-fuel flame 50. The compressed air is used to form an air envelope 54 surrounding the oxygen-fuel flame 50.

The disclosed systems and methods are particularly useful in depositing high melting point materials onto substrates with improved efficiencies than known before. At the outset, the process begins with obtaining nanometer-sized particle feedstock contained in liquid dispersion, preferably a liquid hydrocarbon, which can be kerosene or diesel fuel. Such materials are available from Nanophase Technologies Corp. of 1319 Marquette Drive, Romeoville, Ill. 60446 (http://www.nanophase.com). Materials from Nanophase Technologies Corp. are provided in a dispersion of kerosene or other liquid carrier and have maximum particles sizes of less than 500 nanometers. More preferably, the maximum particles sizes may be less than 200 nanometers, and still more preferably, less than 100 nanometers Typically, the weight percent of particles in the kerosene dispersion is about 40%, which is then reduced to a range of about 0.1 weight percent to about 10 weight percent and more preferably a range of about 2 weight percent to about 6 weight percent prior to use in a HVOF process.

The following nano-sized powdered or particle feedstocks or combinations thereof may be used in accordance with this disclosure are listed in the table below with their respective melting points.

| Composition | Tₘ(° C.) |
|---|---|
| Alumina | 2015 |
| Ceria | 2600 |
| Chromia | 2435 |
| Magnesia | 2800 |
| Silica | 1600 |
| Titania | 1825 |
| Yttria | 2410 |
| Zirconia | 2700 |

The above materials are provided in a stable kerosene dispersion. That is, the nano-sized particle materials do not settle out during shipment, handling and storage. A kerosene pump is used to supply the kerosene dispersion to the combustion chamber of a HVOF thermal spray gun. Utilizing less expensive feedstocks having larger particle sizes exceeding 500 nanometers can prove disadvantageous because the larger particles cause premature wear and tear on a typical kerosene pumps seals thereby causing the pumps to prematurely lose pressure and leak.

In addition to the single component particle feedstocks listed above in Table 1, mixtures of particle feedstocks can be employed. For example, mixtures of alumina and chromia, alumina and magnesia, alumina and silica, alumina and titania, chromia and silica and titania, titania and chromia and zirconia and yttria can also be utilized and may have numerous commercial applications.

The kerosene dispersion and oxygen-fuel mixture are injected into a HVOF thermal spray gun. One useful gun is manufactured by WearMaster, Inc. of 105 Pecan Drive, Kennedale, Tex. 76060, a division of St. Louis Metallizing (http://www.stlmetallizing.com). Other suitable HVOF spray systems are available from Praxair Surface Technologies of 1555 Main Street, Indianapolis, Ind.

The spray gun utilized should generate sufficiently large droplets of the liquid carrier/particle feedstock dispersion so that as the formed droplets burn as they pass through the combustion chamber, the droplet size will shrink and encourage an agglomeration of the melting nano-sized particles. The agglomeration of the nano-sized particles in the combustion chamber of the gun will result in an agglomerated mass of molten particles of sufficient mass to strike the substrate with sufficient momentum resulting in an effective deposition. If the agglomerated mass is too small, large amounts of the particle feedstock will be carried away from the substrate with the combustion gases and the efficiency of the process will be reduced.

Referring to FIG. 2, the nozzle assembly 23 is illustrated injecting a stream 60 of the liquid carrier and particle feedstock dispersion. The liquid carrier is preferably a liquid hydrocarbon such that, as the stream 60 proceeds through the combustion chamber 43, individual dispersion droplets 62 are formed.

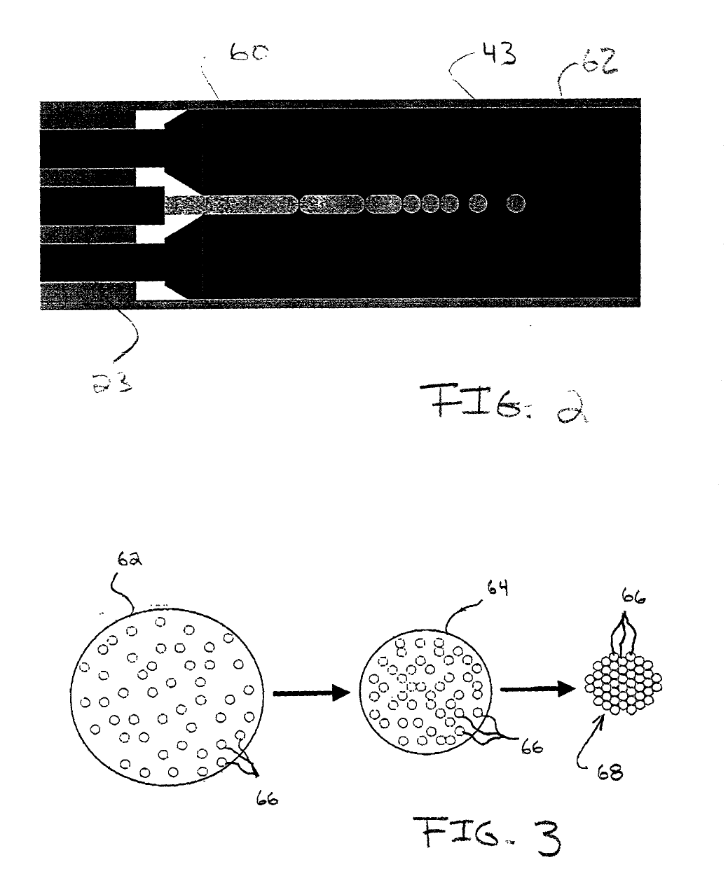

Turning to FIG. 3, as an individual droplet 62 proceeds through the combustion chamber 43, the liquid material burns thereby reducing the droplet size to a smaller droplet shown at 64. As the liquid material continues to burn, the nano-sized particles 66 form an agglomerated mass 68. The agglomerated mass 68 includes a plurality of nano-sized particles of the feedstock that, as a result of the high temperatures in the combustion chamber 43, are in a molten or partially molten state. The agglomerated masses 68 have sufficient momentum upon exiting the combustion chamber 43 that a large percentage of the_masses will strike the substrate (not shown) and adhere thereto for a relatively high efficiency. For example, using the WearMaster device, efficiencies of approximately 50% have been demonstrated. This relatively high efficiency is attributed to the fact that the nozzle assembly 23 of the illustrated thermal spray system satisfactorily inject the liquid carrier and particle feedstock dispersion into the combustion chamber 43 in such a manner so that droplets 62 of a sufficient size are formed so that the process illustrated in FIG. 3 is carried out in the combustion chamber 43. (See FIG. 1 and 2). In contrast, a nozzle assembly 23 that is an efficient atomizer would not produce droplets 62 of a sufficient size, would therefore not produce agglomerated masses 68 of a sufficient mass, and therefore an effective atomizing nozzle assembly would be less efficient. Thus, interchangeability of the nozzle assembly 23 may alter the size of the individual dispersion droplets 62 formed that may be used to effectively control the mechanical and physical properties of the resulting coating on the target substrate.

To ensure the melting of the nano-sized particle feedstock, a high combustion temperature fuel, along with oxygen, is preferably injected into the HVOF thermal spray equipment. One preferred fuel with a sufficiently high combustion temperature is methylacetylenepolypropadiene (MAPP). The use of the high combustion temperature fuel is preferred for applying materials with a melting point exceeding 2400° C., such as ceria, chromia, magnesia, yttria and zirconia (see Table 1). When utilizing MAPP as a fuel and these higher melting point particle feedstocks may require increasing the cooling capacity of the thermal spray system. Further, to maintain the combustion temperature within the chamber sufficiently high, stainless steel combustion barrels or nozzles may be preferred over copper and brass materials, which are often standard in such thermal spray guns. Other suitable high combustion temperature fuels will be apparent to those skilled in the art.

FIG. 4 is an optical photograph of an alumina coating 72 deposited on a copper substrate 73 in accordance with the disclosed process. The coating 72 was deposited using oxygen feed at 100 psi, a MAPP feed at 80 psi and a liquid hydrocarbon (kerosene) and particle feedstock dispersion at 50 psi. The copper substrate 73 was rotated at 300 rpm and the standoff, or distance between the gun barrel and the substrate, was 3 inches. The barrel diameter was 0.325 inch and the barrel length was 6 inches, with a flared end. The barrel was fabricated from brass. The dispersion feed to the injector included 3% alumina nano-sized particles dispersed in kerosene. As seen from FIG. 4, minimal cracking occurs in a near monolithic structure of the coating 72 has been formed.

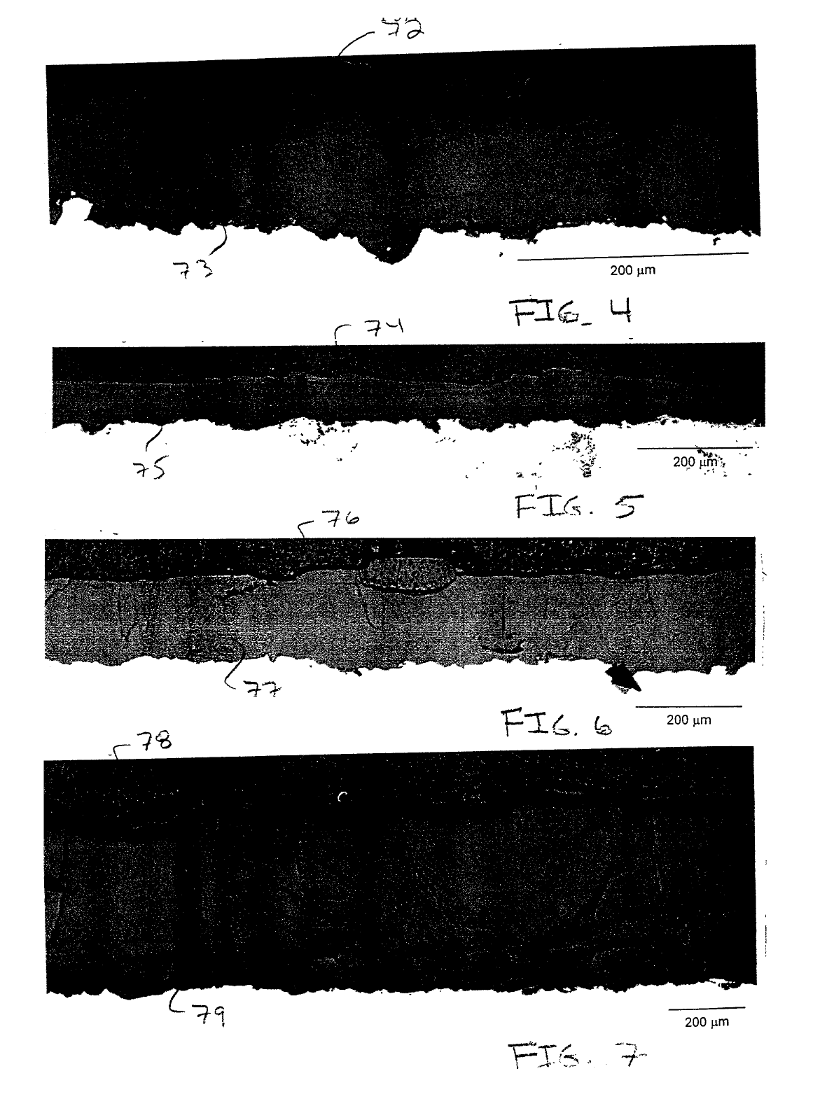

Turning to FIG. 5, a titania-chromia coating 74 having a titania:chromia ratio of about 55:45 was deposited on a copper substrate 75 using the methods disclosed herein. The oxygen feed was provided to the spray system at 180 psi, the MAPP feed was provided at 120 psi and the kerosene-titania-chromia dispersion was provided to the spray system at 50 psi. The copper substrate 75 was rotated at 300 rpm with a standoff of 3 inches. The barrel diameter was 0.5 inch and the barrel length was 6 inches. The barrel was fabricated from stainless steel and the spray duration was 2 minutes.

Likewise, FIG. 6 also depicts a titania-chromia coating 76 having a titania:chromia ratio of about 55:45 was deposited on a copper substrate 77 using the methods disclosed herein. The oxygen feed was provided to the spray system at 180 psi, the MAPP feed was provided at 120 psi and the kerosene-titania-chromia dispersion was provided to the spray system at 50 psi. The substrate 77 was rotated at 300 rpm with a standoff of 3 inches. The barrel diameter was 0.5 inch and the barrel length was 6 inches. The barrel was fabricated from stainless steel and the spray duration was 6 minutes.

Finally, FIG. 7 also depicts an alumina-titania coating 78 having a titania:chromia ratio of about 87:13 was deposited on a copper substrate 79 using the methods disclosed herein. The oxygen feed was provided to the spray system at 180 psi, the MAPP feed was provided at 120 psi and the kerosene-alumina-titania dispersion was provided to the spray system at 55 psi. The substrate 79 was rotated at 300 rpm with a standoff of 3 inches. The barrel diameter was 0.5 inch and the barrel length was 6 inches. The barrel was fabricated from stainless steel and the spray duration was 3.5 minutes.

The table below provides micro hardness measurements of the various ceramic coating samples depicted in FIGS. 4 through 7 as well as micro hardness measurements of bulk Alumina, Chromia, and Titania. Three Vickers indents were produced for each ceramic coating sample specimen, and the average and standard deviation of such measurements are provided.

| Coating Composition | Hardness (HV) | Reference Fig. |
|---|---|---|
| Alumina (Bulk) | 2720 (HV_{.05}) | N/A |
| Chromia (Bulk) | 2955 (HV_{.??}) | N/A |
| Titania (Bulk) | 900 +/− 200 (HV_{.5}) | N/A |
| Alumina | 1100 +/− 80 (HV₀₅) | |
| Titania-Chromia (55:45) | 1243 +/− 53 (HV₀₅) | |
| Titania-Chromia (55:45) | 1542 +/−46 (HV₀₅) | |
| Alumina-Titania (87:13) | 1772 +/− 43 (HV_{.05}) | |

The hardness characteristics of the ceramic coatings applied with the disclosed system and process proved interesting. For example, the alumina-titania coating demonstrated a hardness significantly better than an HVOF alumina coating or bulk titania. This data suggests that the combination of ceramic materials such as alumina and titania at the nano-size particle level may result in solid state chemistry reactions occurring within the thermal spray system. In this case, the alumina may be reacting with titania to form, to some extent, the much harder aluminum-titanate structure (Al₂TiO₅) within the combustion chamber of the thermal spray system and then being deposited on the substrate. Thus, properly controlled, the disclosed systems and methods may provide a means to achieve superior coatings in a commercially feasible manner.

In addition, the dielectric strength of the alumina coating 72 of FIG. 4 was measured at about 250 volts/0.001 inch, which compares favorably with alumina coatings generated using plasma thermal spray technology, which have a dielectric strength of about 200 volts/0.001 inch.

Referring back to FIG. 1, the thermal spray system 10 preferably includes one or more sources of liquid carrier and nano-sized particle material dispersions 40, 42, the supply of which is controlled by a system control unit 80. In the illustrated embodiment, the system control unit is operatively coupled to control valves, pumps, or other flow metering and control devices 82, 84 associated with each of the sources of liquid carrier and nano-sized particle material dispersions 40, 42. By actively or automatically controlling the injection parameters, such as pressure differentials and flow rates of the various liquid carrier/nano-sized particle dispersions, as well as the flow parameters of the air, oxygen and fuel sources, the system control unit 80 may precisely control the relative composition of the coating materials introduced into the oxygen-fuel flame 50. It is envisioned that using such a system approach, the layering of coatings or gradation of coatings can be achieved, and more importantly, controlled to produce a wide spectrum of applied coatings having very specific physical and chemical properties. The physical and chemical properties of the coating being dependent on the dispersions selected as well as the control of injection parameters.

In addition, the system control unit 80 can be adapted to control the nozzle assembly 23 configuration of the thermal spray system 10 or at least control the injection parameters based, in part, on the nozzle configuration.

Variable nozzle configurations and associated actuation schemes can be employed to achieve the desired control of the nozzle assembly configuration.

Industrial Applicability

As shown in FIGS. 4 through 7, coatings of high melting point materials such as alumina (Tₘ=2015° C.), titania-chromia (Tₘ=1825° C., 2435° C., respectively), and alumina-titania (Tₘ=2015° C., 1825° C., respectively) can be applied to substrates that are prone to oxidation, such as copper. The coatings of other high melting point materials such as ceria, magnesia, silica, yttria and zirconia and mixtures thereof can also be utilized to provide coatings on metallic substrates and other substrates prone to oxidation or fouling. Suitable particle feedstocks of these materials having sufficiently small particulate sizes of less than 500 nanometers are available from Nanophase Technologies Corp. as well as mixtures thereof.

Other advantages and features of the disclosed systems, methods, articles and processes can be obtained from the study of the drawings, the disclosure and the appended claims.

What is claimed is:

1. A method for coating a nano-sized particle material on a substrate, the method comprising:
providing a dispersion of the nano-sized particle material in a liquid carrier, the material including individual, non-agglomerated particles having diameters of less than 500 nm;
injecting the dispersion into a thermal spray to form droplets of liquid carrier and particles;
burning the droplets of liquid carrier and particles within the thermal spray so the particles begin to melt and wherein as the droplets burn, at least some of the particles begin to form agglomerates of particles within the droplets; and
directing the droplets containing the agglomerates of particles toward the substrate to coat the substrate.

2. The method of claim 1 wherein the dispersion includes from about 0.1 wt % to about 10 wt % of the particles.

3. The method of claim 1 wherein the dispersion includes from about 2 wt % to about 6 wt % of the particles.

4. The method of claim 1 wherein the liquid carrier is kerosene.

5. The method of claim 1 wherein the liquid carrier is diesel fuel.

6. The method of claim 1 wherein the nano-sized particle material is selected from the group consisting of alumina, chromia, magnesia, silica, titania, ceria, zirconia, yttria and mixtures thereof.

7. The method of claim 1 wherein the nano-sized particle material is selected from the group consisting of alumina, a mixture of alumina and chromia, a mixture of alumina and magnesia, a mixture of alumina and silica, a mixture of alumina and titania, ceria, chromia, a mixture of chromia, silica and titania, a mixture of titania and chromia and a mixture of zirconia and yttria.

8. The method of claim 1 wherein the particles in the dispersion have diameters of less than 200 nm.

9. The method of claim 1 wherein the particles in the dispersion have diameters of less than 100 nm.

10. The method of claim 1 wherein the substrate is metallic.

11. The method of claim 1 wherein the particles in the dispersion have melting points of at least 1600° C.

12. The method of claim 6 wherein at least some of the particles have melting points exceeding 2000° C.

13. A method for coating high melting point material on a substrate, the method comprising:
mixing the high melting point material with a liquid carrier to provide a dispersion of the material in the liquid carrier, the material including individual, non-agglomerated particles having diameters of less than 500 nm;
injecting the dispersion, together with oxygen into a thermal spray to form burning droplets of liquid carrier and particles so as to initiate the melting of the particles;
wherein as the droplets of liquid carrier and particles burn, the droplets decrease in size at least some of the particles begin to form agglomerates of particles within the droplets; and
spraying the droplets of liquid carrier and particles toward the substrate to coat the substrate.

14. The method of claim 13 wherein the dispersion is stable and includes from about 0.1 wt % to about 10 wt % of the particles.

15. The method of claim 13 wherein the liquid carrier is kerosene.

16. The method of claim 13 wherein the liquid carrier is diesel fuel.

17. The method of claim 13 wherein the step of injecting the dispersion, together with oxygen into a thermal spray further includes injecting the dispersion, oxygen, and a source of fuel.

18. The method of claim 17 wherein the source of fuel is a high combustion temperature fuel having combustion temperatures in excess of 2000° C.

19. The method of claim 17 wherein the source of fuel is methyl-acetylene-polypropadiene.

20. The method of claim 13 wherein the material is selected from the group consisting of alumina, chromia, magnesia, silica, titania, ceria, zirconia, yttria and mixtures thereof.

21. The method of claim 13 wherein the material is selected from the group consisting of alumina, a mixture of alumina and chromia, a mixture of alumina and magnesia, a mixture of alumina and silica, a mixture of alumina and titania, ceria, chromia, a mixture of chromia, silica and titania, a mixture of titania and chromia and a mixture of zirconia and yttria.

22. The method of claim 13 wherein the particles in the dispersion have diameters of less than 200 nm.

23. The method of claim 13 wherein the particles in the dispersion have diameters of less than 100 nm.

24. The method of claim 13 wherein the substrate is metallic.

25. The method of claim 13 wherein the particles in the dispersion have melting points of at least 1600° C.

26. The method of claim 13 wherein at least some of the particles have melting points exceeding 2000° C.

27. A thermal spray deposition system comprising:
a thermal spray deposition device;
a source of fuel and a source of oxygen operatively coupled to the thermal spray deposition device for creating a thermal spray;
one or more sources of nano-sized particles dispersed in a liquid carrier in flow communication with the thermal spray deposition device, the dispersion including individual, non-agglomerated nano-sized particles;
a feedstock injection system for injecting one or more of the dispersions of nano-sized particles in the liquid carrier into the thermal spray; and
a system controller for controlling the injection parameters of the feedstock injection system to control one of the composition and droplet size of the dispersions of nano-sized particles in the liquid carrier injected into the thermal spray.

28. The system of claim 27 wherein the dispersion includes from about 0.1 wt % to about 10 wt % of the nano-sized particles.

29. The system of claim 27 wherein the dispersion includes from about 2 wt % to about 6 wt % of the nano-sized particles.

30. The system of claim 27 wherein the nano-sized particles are selected from the group consisting of alumina, chromia, magnesia, silica, titania, ceria, zirconia, yttria and mixtures thereof.

31. The system of claim 27 wherein the nano-sized particles are selected from the group consisting of alumina, a mixture of alumina and chromia, a mixture of alumina and magnesia, a mixture of alumina and silica, a mixture of alumina and titania, ceria, chromia, a mixture of chromia, silica and titania, a mixture of titania and chromia and a mixture of zirconia and yttria.

32. The system of claim 27 wherein the particles in the dispersion have diameters of less than 500 nm.

33. The system of claim 27 wherein the particles in the dispersion have diameters of less than 100 nm.

34. The system of claim 27 wherein the nano-sized particles in the dispersion have melting points of at least 1600° C.

35. The system of claim 27 wherein at least some of the nano-sized particles have melting points exceeding 2000° C.

36. The system of claim 27 wherein the liquid carrier is kerosene.

37. The system of claim 27 wherein the liquid carrier is diesel fuel.

38. The system of claim 27 further including at least two distinct sources of nano-sized particles dispersed in liquid carriers, the nano-sized particles are selected from the group consisting of alumina, chromia, magnesia, silica, titania, ceria, zirconia, and yttria.

39. The system of claim 27 wherein the injection parameters include the differential pressure of one or more dispersions of nano-sized particles within the liquid carrier through the feedstock injection system.

40. The system of claim 27 wherein the injection parameters include nozzle configuration used to inject one or more dispersions of nano-sized particles within the liquid carrier into the thermal spray.

41. The system of claim 27 wherein the system controller controls the composition of nano-sized particles injected into the thermal spray.

42. The system of claim 27 wherein the system controller controls the droplet size of the dispersions of nano-sized particles in the liquid carrier injected into the thermal spray.

43. The system of claim 27 wherein the system controller controls both the droplet size and composition of the dispersions of nano-sized particles in the liquid carrier injected into the thermal spray.

44. A method of controlling a thermal spray coating process; the method comprising:
operating a thermal spray deposition system having a source of fuel and oxygen to provide a thermal spray;
providing at least one source of nano-sized particles dispersed in a liquid carrier, the dispersion including individual, non-agglomerated particles having diameters of less than 500 nm;
injecting the dispersions of nano-sized particles within the liquid carrier into the thermal spray under conditions such that one of the droplet size of the dispersion of nano-sized particles within the liquid carrier and the composition of nano-sized particles injected into the thermal spray is precisely controlled; and
spraying the droplets of the dispersions of nano-sized particles within the liquid carrier toward a substrate to coat the substrate;
wherein the physical characteristics and composition of the coating on the substrate are manipulated by controlling one of the content and droplet sizes of the dispersions of nano-sized particles within the liquid carrier injected in the thermal spray.

45. The method of claim 44 wherein the dispersion includes from about 0.1 wt % to about 10 wt % of the nano-sized particles.

46. The method of claim 44 wherein the dispersion includes from about 2 wt % to about 6 wt % of the nano-sized particles.

47. The method of claim 44 wherein the nano-sized particles are selected from the group consisting of alumina, chromia, magnesia, silica, titania, ceria, zirconia, yttria and mixtures thereof.

48. The method of claim 44 wherein the nano-sized particles are selected from the group consisting of alumina, a mixture of alumina and chromia, a mixture of alumina and magnesia, a mixture of alumina and silica, a mixture of alumina and titania, ceria, chromia, a mixture of chromia, silica and titania, a mixture of titania and chromia and a mixture of zirconia and yttria.

49. The method of claim 44 wherein the particles in the dispersion have diameters of less than 200 nm.

50. The method of claim 44 wherein the particles in the dispersion have diameters of less than 100 nm.

51. The method of claim 44 wherein the nano-sized particles in the dispersion have melting points of at least 1600° C.

52. The method of claim 44 wherein at least some of the nano-sized particles have melting points exceeding 2000° C.

53. The method of claim 44 wherein the liquid carrier is kerosene.

54. The method of claim 44 wherein the liquid carrier is diesel fuel.

55. The method of claim 44 further including at least two distinct sources of nano-sized particles dispersed in liquid carriers, the nano-sized particles are selected from the group consisting of alumina, chromia, magnesia, silica, titania, ceria, zirconia, and yttria.

56. The method of claim 44 wherein the control of the dispersion injection further includes controlling the differential pressure of one or more dispersions of nano-sized particles within the liquid carrier through the feedstock injection system.

57. The method of claim 44 wherein the control of the dispersion injection further includes adjusting the nozzle configuration used to inject one or more dispersions of nano-sized particles within the liquid carrier into the thermal spray.

58. The method of claim 44 wherein the coating on the substrate is manipulated by controlling the composition of nano-sized particles injected into the thermal spray.

59. The method of claim 44 wherein the coating on the substrate is manipulated by controlling the droplet size of the dispersions of nano-sized particles in the liquid carrier injected into the thermal spray.

60. The method of claim 44 wherein the coating on the substrate is manipulated by controlling both the droplet size and composition of the dispersions of nano-sized particles in the liquid carrier injected into the thermal spray.

61. A high velocity oxygenated fuel (HVOF) coated article comprising:
a substrate;
a coating of agglomerated nano-sized particles deposited on the substrate by high velocity oxygenated fuel (HVOF) thermal spray deposition process,
wherein the agglomerated nano-sized particles being derived from a dispersion of the nano-sized, non-agglomerated particles in a liquid carrier injected into the thermal spray, and
wherein the coating has a dielectric strength at least 20% greater than a dielectric strength of a like coating onto a like substrate using a plasma thermal spray process.

62. The coated article of claim 61 wherein the nano-sized particles are selected from the group consisting of alumina, chromia, magnesia, silica, titania, ceria, zirconia, yttria and mixtures thereof.

63. The coated article of claim 61 wherein the nano-sized particles are selected from the group consisting of alumina, a mixture of alumina and chromia, a mixture of alumina and magnesia, a mixture of alumina and silica, a mixture of alumina and titania, ceria, chromia, a mixture of chromia, silica and titania, a mixture of titania and chromia and a mixture of zirconia and yttria.
